(19) United States
(12) Patent Application Publication
(10) Pub. No.: US 2026/0154343 A1
(43) Pub. Date: Jun. 4, 2026

(54) PROCESSOR SYSTEM, KNOWLEDGE GRAPH GENERATION METHOD, AND PROGRAM

(71) Applicant: Hitachi, Ltd., Tokyo (JP)

(72) Inventors: Tatsuya BABA, Tokyo (JP); Hiroaki ITSUJI, Tokyo (JP); Takumi UEZONO, Tokyo (JP); Kenichi SHIMBO, Tokyo (JP); Tadanobu TOBA, Tokyo (JP)

(21) Appl. No.: 19/400,470

(22) Filed: Nov. 25, 2025

(30) Foreign Application Priority Data
Dec. 2, 2024 (JP) 2024-209635

(51) Int. Cl. G06F 16/901; G06F 16/2458; G06F 16/28

(52) U.S. Cl. CPC G06F 16/9024; G06F 16/2465; G06F 16/288

(57) ABSTRACT

A processor system includes: one or more processors; and one or more memory resources, the memory resource stores a defect knowledge database in which case knowledge information including corrected knowledge graphs in regard to defects is stored, a language processing model, a target defect report sentence, and a program that generates a knowledge graph related to the target defect report sentence, and the processor extracts similar case knowledge information from the defect knowledge database, and specifies named entities and relationships among the named entities in the target defect report sentence by inputting the target defect report sentence and the extracted case knowledge information to the language processing model to generate a knowledge graph.

### BACKGROUND

### Technical Field

The present invention relates to a processor system, a knowledge graph generation method, and a program adapted to extract a factor of a defect from a defect report describing a defect of a product and accurately generate a knowledge graph related to the defect using a reference case of a similar defect.

### Related Art

In the field of industrial products, there has been a current situation in which information related to defects cannot be fully utilized to prevent defects in advance and for next generation design since expressions of report sentences described in reports related to defects differ depending on persons in charge.

Therefore, generating knowledge graphs from defect relationship information by utilizing language processing models such as large language models (LLMs) with high processing capabilities for differences in expressions is considered to be an effective method. On the other hand, the language processing models do not learn domain knowledge such as industrial products and component names, and response accuracy and reliability regarding them are not high. In order to improve the response accuracy by the language processing models, there is a method of giving a high-quality knowledge graph which is data including necessary domain knowledge.

Note that JP 2023-39656 A discloses a technique related to a case search apparatus that enables search with a high degree of freedom. Specifically, J P 2023-39656 A includes description of “A case search apparatus according to an embodiment includes a first acquisition unit, a second acquisition unit, a calculation unit, a search unit, and a presentation unit. The first acquisition unit acquires a search condition that is data of a search target case. The second acquisition unit acquires a meta search condition that is a description related to a viewpoint to be focused in searching for a case similar to the search condition. The calculation unit calculates similarity between the search condition and each of a plurality of reference cases that are data of searching target cases, on the basis of the meta search condition. The search unit searches for a similar reference case similar to the search condition from the viewpoint of the meta search condition from the plurality of reference cases on the basis of the similarity. The presentation unit presents a result of the searching performed by the search unit.”
Patent document 1 JP 2023-39656 A

### SUMMARY

In order to generate a high-quality knowledge graph with high accuracy, manual correction is required in some cases, and such correction requires a work load and efforts. In order to minimize the work load for manually correcting the knowledge graph, it is considered to be effective to generate a knowledge graph reflecting a correction pattern in reference cases by generating the next and subsequent knowledge graphs using the reference cases that include domain knowledge and have been appropriately corrected.

Note that JP 2023-39656 A discloses a technique of converting the case data as a search target into the meta search condition, calculating similarity in a feature amount space, and searching for similar cases. However, the technique of JP 2023-39656 A does not take reflecting of the past correction pattern to generation of the next and subsequent knowledge graphs using the searched case data into consideration.

The present invention has been made in view of the above problem, and an object thereof is to generate a knowledge graph with high accuracy by generating a knowledge graph using corrected reference cases.

The present application includes a plurality of means for solving at least a part of the above problems, and examples thereof are as follows. A processor system according to an aspect of the present invention to solve the above problem includes: one or more processors; and one or more memory resources, in which the memory resource stores a defect knowledge database in which case knowledge information including corrected knowledge graphs in regard to defects in a product or a part is stored, a language processing model, a target defect report sentence, and a program that generates a knowledge graph related to the target defect report sentence, and the processor executes the program to extract the case knowledge information in which case knowledge similar to the defect indicated by the target defect report sentence is registered from the defect knowledge database, and specify named entities and relationships among the named entities in the target defect report sentence by inputting the target defect report sentence and the extracted case knowledge information to the language processing model and generate a knowledge graph related to the target defect report sentence on the basis of the specified named entities and the relationships.

According to the present invention, it is possible to generate a knowledge graph with high accuracy by generating a knowledge graph using corrected reference cases.

### BRIEF DESCRIPTION OF DRAWINGS

FIG. 1 is a diagram illustrating an example of a schematic configuration of a processor system;

FIG. 2 is a diagram schematically illustrating a defect knowledge DB;

FIG. 3 is a diagram illustrating an example of a knowledge graph;

FIG. 4 is a diagram illustrating an example of a case defect report sentence;

FIG. 5 is a flowchart illustrating an example of knowledge DB update processing;

FIG. 6 is an explanatory diagram of entire knowledge DB update processing;

FIG. 7 is an explanatory diagram of reference case search processing;

FIG. 8 is a flowchart illustrating knowledge graph generation processing;

FIG. 9 is an explanatory diagram of the knowledge graph generation processing;

FIG. 10A is a diagram illustrating an example of a prompt, and FIG. 10B is a diagram illustrating an example of named entity data;

FIG. 11 is a diagram illustrating a named entity list and a relationship list, and an example of a case defect report sentence;

FIG. 12A is a diagram illustrating an example of a prompt, and FIG. 12B is a diagram illustrating an example of relationship data;

FIG. 13 is a diagram illustrating an example of a prompt;

FIG. 14 is a diagram illustrating a correction example of the knowledge graph;

FIG. 15A is a diagram illustrating an example of a knowledge graph feature amount, and FIG. 15B is a diagram illustrating an example of each element of a calculation formula to be used to generate a correction feature amount;

FIG. 16 is a diagram illustrating an example of a user interface screen;

FIG. 17 is a flowchart illustrating an example of correction processing;

FIG. 18 is an explanatory diagram of entire knowledge DB update processing; and

FIG. 19 is a diagram illustrating an example of a user interface screen.

### DETAILED DESCRIPTION

The following embodiment is an example for explaining the present invention, and omission and simplification have appropriately been made for clarity of the explanation. The present invention can be implemented in various other forms. In addition, the number of each kind of components may be one or more unless otherwise particularly limited.

In addition, the position, the size, the shape, the range, and the like of each component illustrated in the drawings may not represent its actual position, size, shape, range, and the like for easiness of understanding of the present invention. Therefore, the present invention is not necessarily limited to the positions, the sizes, the shapes, the ranges, and the like disclosed in the drawings.

Furthermore, although there may be a case where expressions such as a “table”, a “list”, and a “queue” are used as examples of various kinds of information for the explanation, the various kinds of information may be expressed by a data structure as well as these examples. For example, various kinds of information such as an “XX table”, an “XX list”, and an “XX queue” may be referred to as “XX information”. Expressions such as “identification information”, an “identifier”, a “name”, an “ID”, and a “number” are used for explaining identification information, and these can be replaced with each other.

In addition, in a case where there are a plurality of components having the same function or similar functions, description may be given by applying different indexes to the same reference signs. In a case where there is no need to distinguish the plurality of components, description may be given by omitting the indexes.

In the embodiment, processing performed by executing a program may be described. Here, a computing device executes the program by a processor (for example, a CPU or a GPU) and performs processing defined by the program using a storage resource (for example, a memory), an interface device (for example, a communication port), and the like. Therefore, a subject of the processing performed by executing the program may be regarded as the processor.

Similarly, the subject of the processing performed by executing the program may be regarded as a controller, an apparatus, a system, a computing device, or a node including the processor. The subject of the processing performed by executing the program may be any calculation unit and may include a dedicated circuit for performing specific processing. Here, the dedicated circuit is, for example, a field programmable gate array (FPGA), an application specific integrated circuit (ASIC), a complex programmable logic device (CPLD), or the like.

The program may be installed on the computing device from a program source. The program source may be, for example, a program distribution server or a storage medium that can be read by the computing device. In a case where the program source is a program distribution server, the program distribution server may include a processor and a storage resource for storing the distribution target program, and the processor of the program distribution server may distribute the distribution target program to other computing devices. In the embodiment, two or more programs may be implemented as one program, or one program may be implemented as two or more programs.

Hereinafter, the embodiment of the present invention will be described with reference to the drawings.

### <Schematic Configuration of Processor System 100>

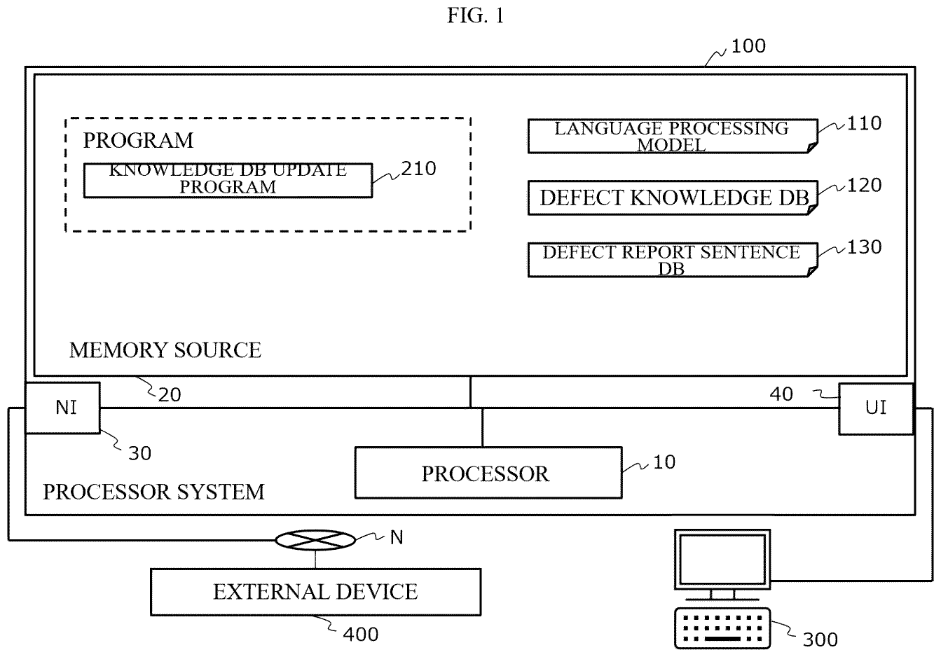

FIG. 1 is a diagram illustrating an example of a schematic configuration of a processor system 100. The processor system 100 is a system that updates a defect knowledge database (DB) by generating a knowledge graph related to a defect report sentence of a processing target, feature amounts thereof, and the like using a case knowledge graph and the like stored in the defect knowledge DB and storing the knowledge graph, the feature amounts, and the like in the database.

Specifically, the processor system 100 extracts a similar reference case related to a defect from the defect knowledge DB using a defect report sentence describing content of a defect of a product (apparatus) or a part or the like in the field of industrial devices, for example.

In addition, the processor system 100 specifies named entities and relationships among the named entities from the target defect report sentence on the basis of knowledge information (such as a case knowledge graph) of the reference case using a language processing model and generates a knowledge graph thereof.

In addition, the processor system 100 corrects the named entities and the relationships among the named entities in the generated knowledge graph in accordance with a predetermined rule (restriction).

Moreover, the processor system 100 calculates the feature amount of the corrected knowledge graph and the feature amount of the correction.

Furthermore, the processor system 100 updates the database by storing the generated (calculated) knowledge graph and each feature amount in the defect knowledge DB for the target defect report sentence.

According to such a processor system, it is possible to reflect a pattern of correction performed in the past to next and subsequent generation of knowledge graphs and to thereby generate a knowledge graph with high accuracy from a defect report sentence. As a result, a work load for manually correcting the knowledge graph can be minimized.

Although the technical field of the product or the part indicated by the defect report sentence is not particularly limited, the following description will be given by exemplifying processing related to a defect report sentence for diesel generator in the present embodiment.

### <Configuration of Processor System 100>

The processor system 100 is a computing device that generates knowledge information regarding defects of a product or the like and accumulates the knowledge information in a database. Specifically, the processor system 100 generates a knowledge graph for a target defect report sentence by a processor 10 reading a program and information stored in a memory resource 20, and updates the database by calculating a feature amount of the knowledge graph and correction feature amount thereof and registering such information as case knowledge information. Details of processing executed by the processor system 100 will be described later.

Note that the processor system 100 is, for example, a computing device such as a personal computer, a server computing device, a cloud server, a tablet terminal, or a smartphone and is a system including at least one or more of these computing devices.

As illustrated in FIG. 1, the processor system 100 includes the processor 10, the memory resource 20, a network interface (NI) device 30, and a user interface (UI) device 40.

The processor 10 is a calculation device that reads various programs stored in the memory resource 20 and executes processing corresponding to each program. Note that the processor 10 is a device capable of executing calculation processing, such as a microprocessor, a central processing unit (CPU), a graphics processing unit (GPU), a field programmable gate array (FPGA), or a semiconductor device.

The memory resource 20 is a storage device that stores various kinds of information. Specifically, the memory resource 20 is a nonvolatile or volatile storage medium such as a random access memory (RAM) or a read only memory (ROM), for example. Note that the memory resource 20 may be, for example, a rewritable storage medium such as a flash memory, a hard disk drive (HDD), or a solid state drive (SSD), a universal serial bus (USB) memory, a memory card, or a hard disk.

The NI 30 is a communication device that performs information communication with an external device (for example, an external device 400). The NI 30 performs information communication with an external device via a predetermined communication network N such as a local area network (LAN) or the Internet, for example. Note that it is assumed that information communication between the processor system 100 and an external device is executed via the NI 30 unless otherwise particularly specified below.

The UI 40 is an interface between an input device for inputting an instruction of a user (operator) to the processor system 100 and an output device for outputting information generated by the processor system 100 (hereinafter, the input device and the output device may be collectively referred to as an input/output device 300). Note that examples of the input device include a keyboard, a touch panel, a pointing device such as a mouse, and a sound input device such as a microphone. Examples of the output device include a display, a printer, and a sound synthesis device. Note that it is assumed that an operation (for example, an instruction for executing an input, an output, and processing of information) performed by the user on the processor system 100 is received via the UI 40.

In addition, some or all of configurations, functions, processing mechanisms, and the like of the processor system 100 may be implemented by hardware by designing them in an integrated circuit, for example. Also, some or all of the functions of the processor system 100 can be implemented by software or can be implemented by cooperation between software and hardware. Furthermore, the processor system 100 may use hardware having a fixed circuit or may use hardware in which at least a part of circuits can be changed.

Furthermore, it is also possible to implement, as the processor system 100, a system by the user (operator) performing some or all of functions or processes implemented by programs.

Note that a database and various kinds of information in the memory resource 20 described below may be stored in files or in a data structure other than the database as long as it is possible to store the data in the region.

Various kinds of information including the database in the memory resource 20 do not need to be stored in the memory resource 20 in advance and may be acquired from an external device (the external device 400) every time corresponding processing is performed.

### <<Language Processing Model 110>>

The language processing model 110 is an algorithm or a learning model (information model) capable of predicting and generating appropriate words from text data in accordance with context through natural language processing, and in the present embodiment, a large language model (LLM: deep learning model), for example, is assumed.

### <<Defect Knowledge DB 120>>

The defect knowledge database (DB) 120 is a database storing reference case knowledge information. Specifically, the defect knowledge DB 120 stores a case knowledge graph and a case defect report sentence, a case knowledge graph feature amount, and a case correction feature amount corresponding thereto.

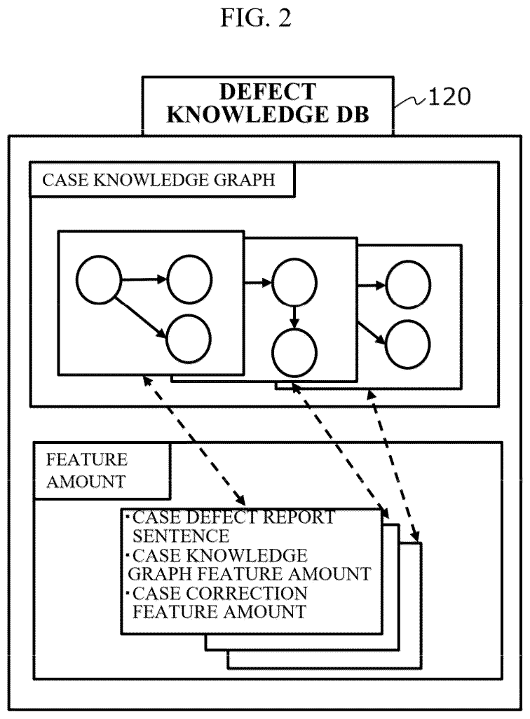

FIG. 2 is a diagram schematically illustrating the defect knowledge DB. The case knowledge graph stored in the defect knowledge DB 120 is generated for the defect report sentence, indicates relationships among nodes by regarding information such as a location related to a defect in a target product (apparatus) or a part, a component, a phenomenon (status), and the like as nodes, hierarchically expresses an inclusion relationship between the defect location and a unit constituting it, and expresses a reason why a phenomenon (breaking or a state that may cause the breaking) that may occur in each part may occur at another location and a result thereof.

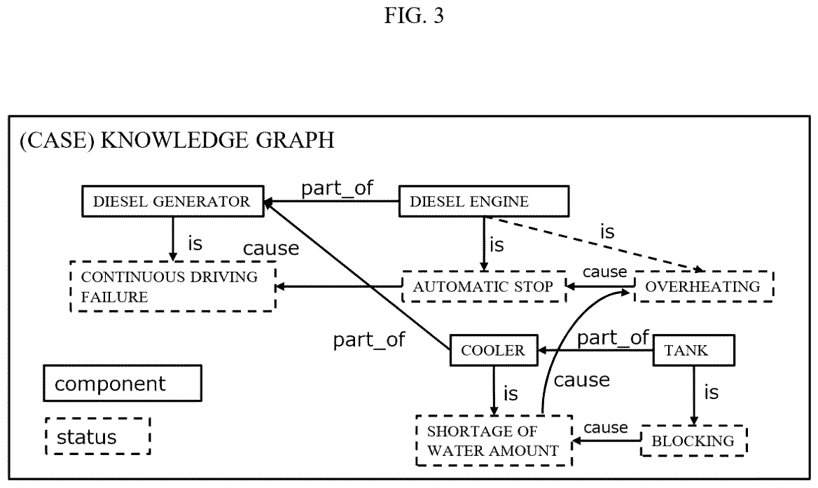

FIG. 3 is a diagram illustrating an example of the knowledge graph (case knowledge graph). As illustrated in the drawing, a relationship between a phenomenon (status) and an occurrence location (component) of the phenomenon is represented by each arrow (start: occurrence location, end: phenomenon) as “is edge” in the knowledge graph in the present embodiment. Furthermore, a causal relationship between a cause and a result of the phenomenon is represented by each arrow (start: cause, end: result) as “cause edge” in the knowledge graph. Furthermore, an inclusion relationship between a device and a component (part) thereof is represented by each arrow (start: component, end: device including the component) as “part of edge” in the knowledge graph. Note that the causal relationship represented by the cause edge in the knowledge graph may be caused to have coefficient information, and the coefficient information may be, for example, in the Bayesian network format caused to have probability information such as a conditional probability, for example.

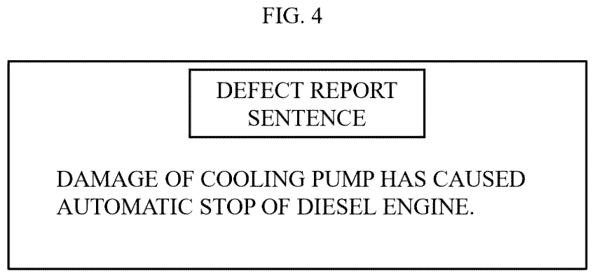

FIG. 4 is a diagram illustrating an example of a case defect report sentence. The case defect report sentence stored in the defect knowledge DB 120 is a defect report sentence corresponding to each case knowledge graph, and is information in which a text sentence indicating contents related to a defect of a product (apparatus) or a part is registered.

The case knowledge graph feature amount stored in the defect knowledge DB 120 is information expressing the case knowledge graph as a vector format (vector format, the same applies to the following description) feature amount. In addition, the case correction feature amount is information that expresses correction having been performed on the case knowledge graph as a vector format feature amount (correction burden). Note that the correction applied to the case knowledge graph is, for example, correction performed on the unique representation of the knowledge graph and the relationship between the unique representations by the processor system 100 or manually, and the case correction feature amount is a feature amount generated on the basis of comparison between the knowledge graph before correction and the knowledge graph after correction.

In addition, the case knowledge graph, the case defect report sentence, the case knowledge graph feature amount, and the case correction feature amount correspond to each other in a one-to-one relationship.

### <<Defect Report Sentence DB 130>>

The defect report sentence DB 130 is a database that stores a defect report sentence to be processed for generating a knowledge graph and a feature amount thereof using the case knowledge graph, the case defect report sentence, and the like stored in the defect knowledge DB 120. Such a defect report sentence is created, for example, by extracting a document related to a defect from a defect report created by a person who is in charge of maintenance, for example. Note that since the content of the target defect report sentence is similar to the case defect report sentence, detailed description will be omitted.

### <<Knowledge DB Update Program 210>>

A knowledge DB update program 210 is a program for executing knowledge DB update processing to generate a knowledge graph related to a target defect report sentence and calculate a feature amount and storing the knowledge graph and the feature amount in the defect knowledge DB 120. Note that details of the knowledge DB update processing will be described later.

The details of the processor system 100 have been described above.

### <<External Device 400>>

The external device 400 is a device that transmits information to be input to the processor system 100. The external device 400 is also a device that acquires information generated by the processor system 100. Specifically, the external device 400 may transmit reference case knowledge information to the processor system 100. In addition to such information, the external device 400 may provide (transmit) various kinds of information to be used for processing executed in the processor system 100 to the processor system 100, for example. Furthermore, the external device 400 may store the information generated by the processor system 100 or may display the information on a display included in the external device 400.

### <Knowledge DB Update Processing>

Next, the knowledge DB update processing executed by the processor system 100 will be described.

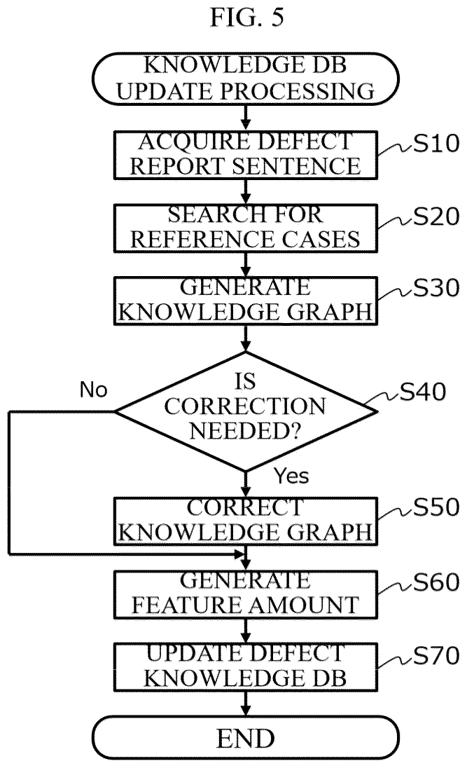

FIG. 5 is a flowchart illustrating an example of the knowledge DB update processing.

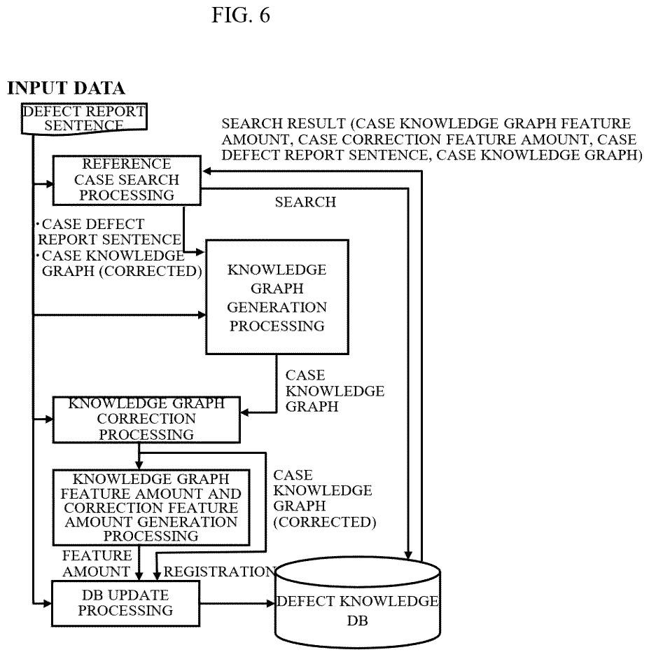

FIG. 6 is an explanatory diagram of the entire knowledge DB update processing including a data flow. Note that the processing is started once the processor system 100 receives an input of an instruction from the user. At this time, the processor 10 executes the following processing by reading the knowledge DB update program 210 inside the memory resource 20 and acquiring and using necessary information from the memory resource 20 in accordance with a processing stage.

Once the processing is started, the processor 10 acquires the defect report sentence to be processed from the defect report sentence DB 130 inside the memory resource 20 (Step S10).

Next, the processor 10 searches for a reference case (Step S20). Specifically, the processor 10 searches for reference case knowledge information to be used to generate a knowledge graph of the defect report sentence from the defect knowledge DB 120 using the acquired defect report sentence as input data.

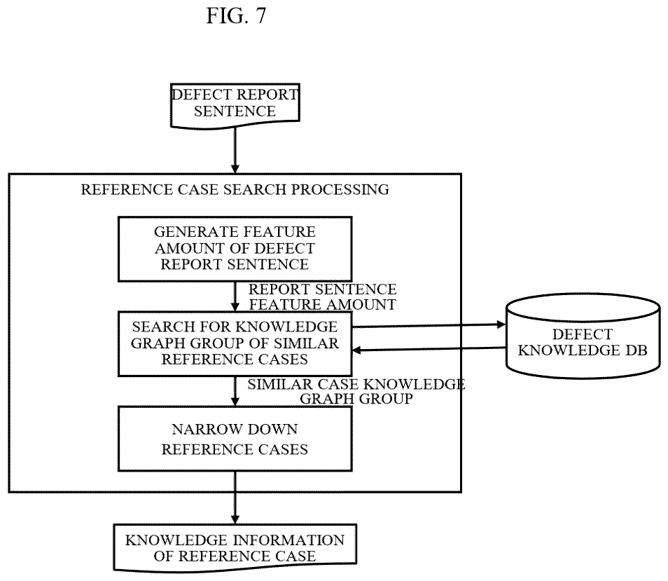

FIG. 7 is an explanatory diagram of reference case search processing including a data flow. In the searching, the processor 10 generates the feature amount of the defect report sentence. Specifically, the processor 10 inputs the input defect report sentence to a predetermined learning model such as a neural network and generates a report sentence feature amount in a vector embedding format based on words included in the defect report sentence and positional relationships among them.

In addition, the processor 10 searches for knowledge information of reference cases similar to the defect report sentence from the defect knowledge DB 120 using the generated report sentence feature amount. Specifically, the processor 10 performs vector search (vector search; the same applies to the following description) on the defect knowledge DB 120 on the basis of the report sentence feature amount and acquires a case knowledge graph group (including case knowledge graphs, and case defect report sentences, case knowledge graph feature amounts, and case correction feature amounts corresponding thereto) with high cosine similarities of case knowledge graph feature amounts with respect to the report sentence feature amount. Note that the processor 10 may acquire a plurality of case knowledge graph groups with high cosine similarities.

In addition, the processor 10 narrows down reference cases. Specifically, the processor 10 selects a reference case having a larger weighted sum of the cosine similarity and the case correction feature amount (correction burden) from the acquired reference cases. Note that a weight value for each of the similarity and the case correction feature amount is arbitrary. For example, the weight value may be set such that one or more (for example, two) case knowledge graph groups having larger case correction feature amounts are selected. Note that it is possible to generate the knowledge graph regarding the target defect report sentence on the basis of the reference cases reflecting more correction patterns by using the reference cases with larger case correction feature amounts to generate the knowledge graph.

Next, the processor 10 generates the knowledge graph (Step S30). Specifically, the processor 10 generates the knowledge graph using the knowledge information of the reference cases searched from the defect knowledge DB 120 in regard to the target defect report sentence.

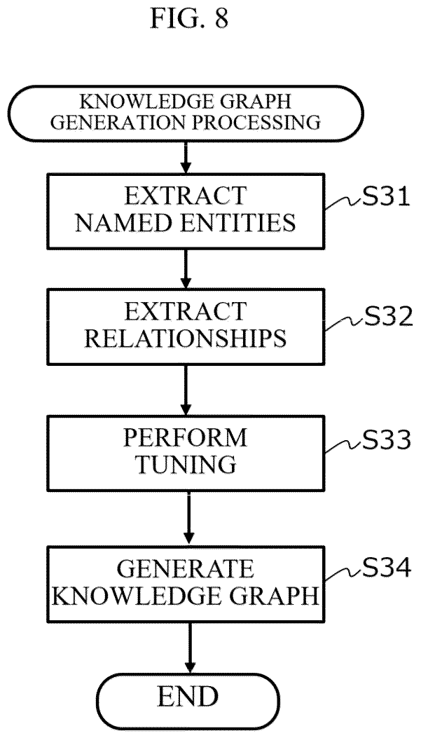

FIG. 8 is a flowchart illustrating knowledge graph generation processing.

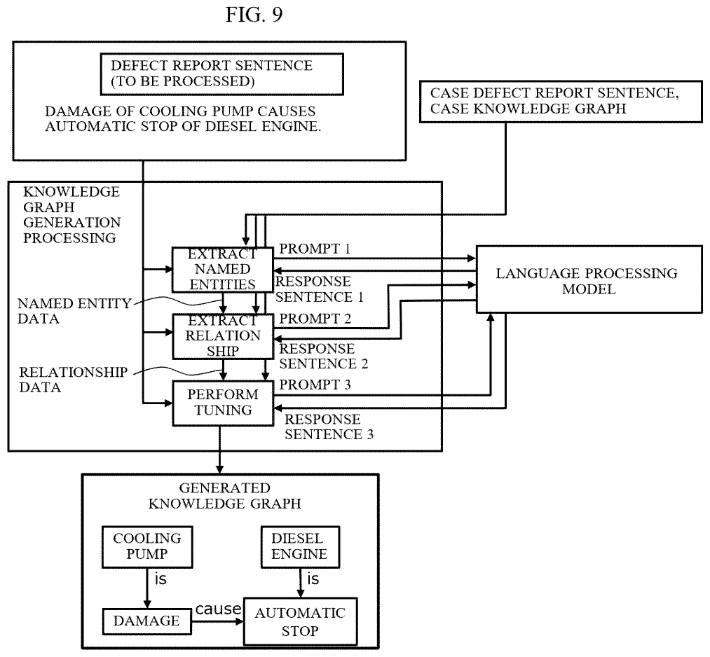

FIG. 9 is an explanatory diagram of the knowledge graph generation processing including a data flow. First, the processor 10 extracts named entities from the target defect report sentence (Step S31). Specifically, the processor 10 generates a prompt 1 describing an instruction sentence for extracting the named entities from the defect report sentence and inputs the prompt 1 to the language processing model 110 (for example, an LLM).

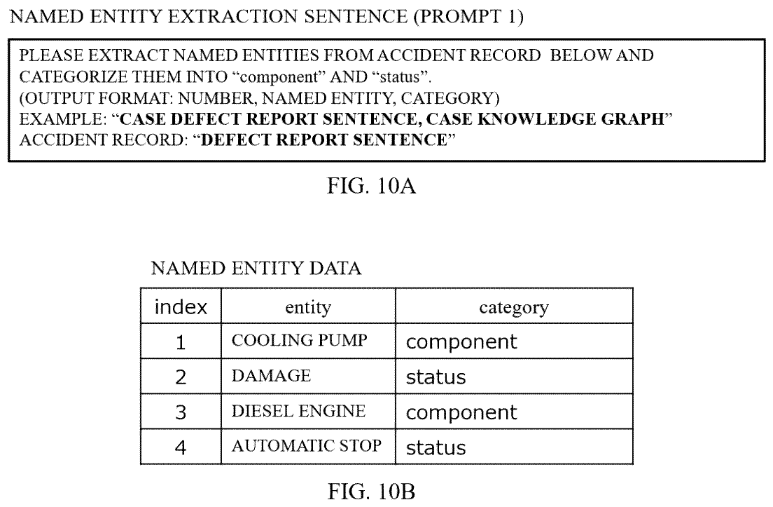

FIG. 10A is a diagram illustrating an example of the prompt 1. The exemplified prompt 1 includes an instruction sentence for providing an instruction to LLM to extract named entities related to a configuration of the product (apparatus) or the like and a defect thereof from the target defect report sentence, categorize the named entities into components and statuses, and output named entity data in a list format including numbers, the named entities, and the categories as items.

In addition, the exemplified prompt 1 includes the case knowledge graph searched for in Step S20 and the case defect report sentence corresponding thereto as a reference case of the named entity extraction. Note that the processor 10 generates a named entity list and a relationship list from the case knowledge graph, converts the named entity list into a predetermined format (for example, a comma separated value format: CSV format), and describes the converted named entity list along with the case defect report sentence in the prompt 1.

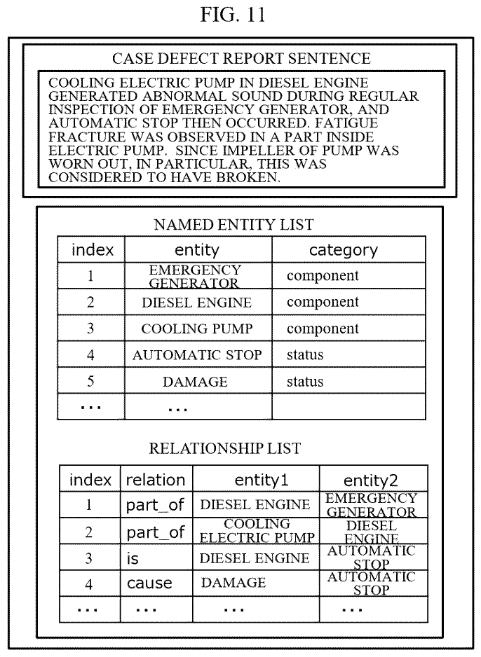

FIG. 11 is a diagram illustrating the named entity list and the relationship list, and an example of the case defect report sentence. As illustrated, the named entity list is generated in a list format in which items of indexes, entities, and categories are associated with each other. In addition, the relationship list is generated in a list format in which indexes, relations, entities 1, and entities 2 are associated with each other. The processor 10 generates such list information from the case knowledge graph, converts it into the CSV format, and describes it in the prompt 1.

Further, the exemplified prompt 1 includes the target defect report sentence (accident record). The processor 10 describes the defect report sentence acquired from the defect report sentence DB 130 in Step S10 in the prompt 1.

The processor 10 acquires the named entity data in the list format by inputting such a prompt 1 to the language processing model 110.

FIG. 10B is a diagram illustrating an example of the named entity data. As illustrated in the drawing, the named entity data is output from the LLM as data in the list format in which items of indexes (numbers), entities (named entities), and categories (categorization) are associated with each other on the basis of the input of the prompt 1.

Next, the processor 10 extracts relationships among the named entities (Step S32). Specifically, the processor 10 generates a prompt 2 that describes an instruction sentence for extracting the relationships among the named entities from the generated named entity data and inputs the prompt 2 to the language processing model 110 (for example, the LLM).

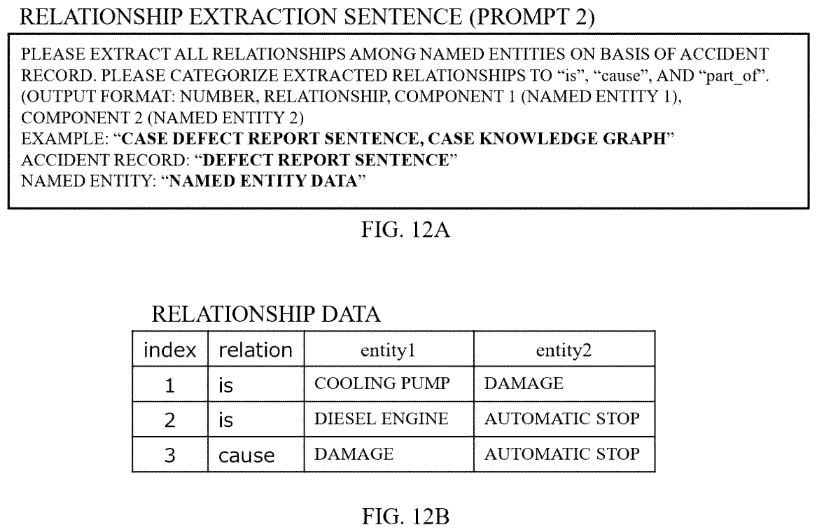

FIG. 12A is a diagram illustrating an example of the prompt 2. The exemplified prompt 2 includes an instruction sentence for providing an instruction to the LLM to extract the relationships among the named entities from the named entity data, categorize the extracted relationships into “is”, “cause”, and “part of”, and output relationship data in the list format including numbers, relationships, components 1 (named entities 1), and components 2 (named entities 2) as items.

In addition, the prompt 2 includes case knowledge graphs and case defect report sentences corresponding to the case knowledge graphs as reference cases for the relationship extraction. Note that the processor 10 converts the named entity list and the relationship list illustrated in FIG. 11 into a predetermined format (for example, the CSV format) and describes them in the prompt 2 together with the case defect report sentence.

The prompt 2 includes the target defect report sentence (accident record) similarly to the prompt 1. Furthermore, the prompt 2 includes the named entity data generated by the prompt 1. The processor 10 converts the named entity data into a predetermined format (for example, the CSV format) and describes the converted data in the prompt 2.

The processor 10 acquires the relationship data in the list format by inputting the prompt 2 including such information to the language processing model 110.

FIG. 12B is a diagram illustrating an example of relationship data. As illustrated in the drawing, the relationship data is output from the LLM as data in the list format in which the items of indexes (numbers), relations (relationships), entities 1 (components 1/named entities 1), entities 2 (components 2/named entities 2) are associated with each other, on the basis of an input of the prompt 2.

Next, the processor 10 performs tuning (Step S33). Specifically, the processor 10 generates a prompt 3 describing content of an instruction to review the named entity data and the relationship data and inputs the prompt 3 to the language processing model 110 (for example, the LLM).

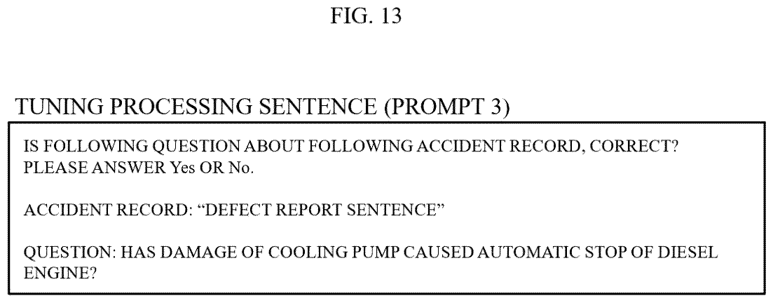

FIG. 13 is a diagram illustrating an example of the prompt 3. The illustrated prompt 3 exemplifies an instruction sentence for providing an instruction to review the relationship data in a question format to the language processing model 110. Note that an instruction sentence for providing an instruction to review the named entity data may also be described in the prompt 3 as well as an instruction to review the relationship data. As for the named entity data, for example, there may be an instruction sentence for providing an instruction to review whether or not “component” has been registered in the category corresponding to a named entity of a product or a part or whether or not “status” has been registered in the category corresponding to a named entity of a phenomenon.

As for the relationship data, for example, there may be an instruction sentence for providing an instruction to review whether or not named entities of appropriate categories have been registered in the entity 1 and the entity 2 in accordance with the “relation” (“is”, “cause”, or “part of”) (in a case where “relation” is “is”, whether or not a named entity of “component” has been registered in the entity 1 while a named entity of “status” has been registered in the entity 2).

There are various such instruction sentences, and it is only necessary for the processor 10 to appropriately select an instruction sentence from a database (not illustrated) in the memory resource 20 in which these instruction sentences have been registered and to describe the selected instruction sentence in the prompt 3, for example.

Next, the processor 10 generates a knowledge graph (Step S34). Specifically, the processor 10 generates a knowledge graph (illustrated as an example in FIG. 3) in which “components” and “statuses” are included as nodes on the basis of the named entity data and relationships among the nodes are associated with each other on the basis of the relationship data and ends the processing of this flow.

According to such knowledge graph generation processing, it is possible to generate a knowledge graph with high accuracy that reflects correction patterns of a target defect report sentence by reference cases being used as long as correction has been performed at least once in the past even if the language processing model 110 has not been caused to learn a large amount of learning data related to the target technical field indicated by the defect report sentence.

Returning to FIG. 5, the description will be given. After the knowledge graph is generated, the processor 10 determines whether or not it is necessary to correct the knowledge graph (Step S40). For example, the processor 10 determines whether or not it is necessary to perform correction in a name of “component”, a causal relationship between a factor and a result of a defect, an inclusion relationship between a product and a part, and the like.

For example, the processor 10 refers basic data of the product or the like indicated by the defect report sentence (for example, data including the name of the product or the part, a rule related to the inclusion relationship of the part with respect to the product, a rule related to the causal relationship between the factor and the result of the defect, and the like; not illustrated) from the memory resource 20. In addition, in a case where the generated knowledge graph includes the name of “component”, the causal relationship between the factor and the result of the defect, the inclusion relationship between the product and the part, or the like that goes against the basic data, the processor 10 determines that it is necessary to perform correction (Yes in Step S40) and moves on to the processing in Step S50. On the other hand, in a case where no locations that go against the basic data are found, the processor 10 determines that it is not necessary to perform correction (No in Step S40) and moves on to the processing in Step S60.

In Step S50, the processor 10 corrects the knowledge graph. Specifically, the processor 10 corrects the knowledge graph in accordance with the rule indicated by the basic data. For example, the processor 10 corrects the name of the product or the part to match the name of the product or the like included in the basic data. Alternatively, the processor 10 corrects a connection relationship of an edge (“cause” edge) indicating the causal relationship or an edge (“part of” edge) indicating the inclusion relationship in accordance with the rule of the basic data.

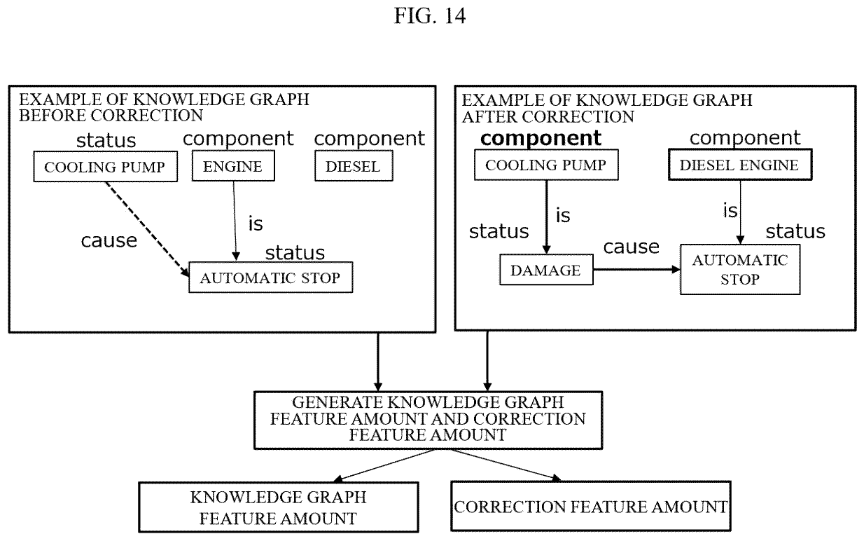

FIG. 14 is a diagram illustrating a correction example of the knowledge graph. As illustrated in the drawing, “engine” and “diesel” have been separately extracted as named entities of a “component” in the knowledge graph before correction generated from a target defect report sentence. Furthermore, an attribute of a cooling pump is extracted as “status”. Although automatic stop of the diesel engine is caused by “damage” of the cooling pump, and the automatic stop is the result thereof, the cooling pump and the automatic stop are connected with a “cause” edge without intervention of the cause of “damage” in the knowledge graph before correction.

In this case, the processor 10 corrects the named entities “engine” and “diesel” to “diesel engine”. In addition, the processor 10 corrects the attribute of the cooling pump from “status” to “component”. Furthermore, the processor 10 performs correction to connect an “is” edge to “damage” indicating the state (status) of the “cooling pump” and connect a “cause” edge from “damage” (cause) to “automatic stop” (result).

Note that the correction of the knowledge graph is not limited to such a method, and any method may be applied as long as it is possible to discover at least locations to be corrected in regard to the name of the product or the part, the inclusion relationship between the product and the part, and the causal relationship between the factor and the result of the defect and to correct the locations to be corrected to an accurate form or relationship.

Next, the processor 10 generates (calculates) a feature amount in Step S60. Specifically, the processor 10 generates a knowledge graph feature amount. In a case where correction has been performed (in a case where Step S50 has been performed), the processor 10 generates (calculates) the knowledge graph feature amount of the knowledge graph after the correction and the correction feature amount.

Specifically, the processor 10 inputs the knowledge graph to a predetermined learning model such as a neural network and generates a knowledge graph feature amount in the vector embedding format based on the named entities and the relationships among the named entities included in the knowledge graph.

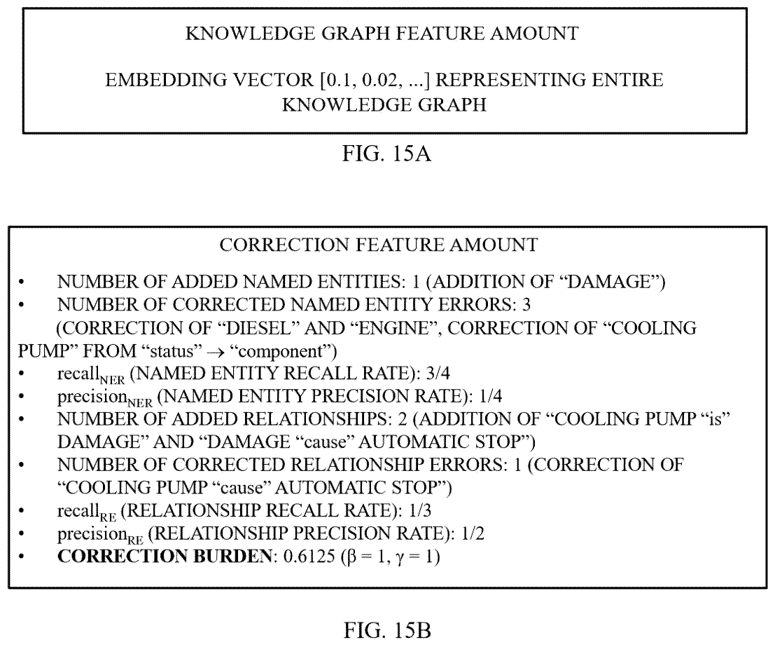

FIG. 15A is a diagram illustrating an example of the knowledge graph feature amount. The processor 10 acquires, as the knowledge graph feature amount, an embedding vector of the knowledge graph as illustrated in the drawing from the predetermined learning model.

In addition, the processor 10 generates the correction feature amount of the knowledge graph using a predetermined calculation formula.

FIG. 15B is a diagram illustrating an example of each element of the calculation formula to be used to generate the correction feature amount. Specifically, the processor 10 calculates a correction burden as the correction feature amount on the basis of Formula (1) below. Note that the correction burden is a value representing the degree of correction burden and is indicated by a floating point number from 0 to 1. Furthermore, γ is a positive floating point number and is a weighting value for determining which one of the F values (F Measures) of NER and RE is to be prioritized.

$$\begin{matrix}[ Mathematical Formula 1 ] & \\ Correction burden = 1 - \frac{1 + {γ}^{2}}{{F}_{NER}^{- 1} + {γ}^{2} {F}_{RE}^{- 1}} & ( 1 )\end{matrix}$$

Here, F_{NER} and F_{RE} are evaluation indexes of a binary categorization task. F_{NER} and F_{RE} can be obtained by Formulae (2) and (3) below.

$$\begin{matrix}[ Mathematical Formula 2 ] & \\ {F}_{NER} = \frac{1 + {β}^{2}}{{recall}_{NER}^{- 1} + {β}^{2} {precision}_{NER}^{- 1}} & ( 2 )\end{matrix}$$

$$\begin{matrix}[ Mathematical Formula 3 ] & \\ {F}_{RE} = \frac{1 + {β}^{2}}{{recall}_{RE}^{- 1} + {β}^{2} {precision}_{RE}^{- 1}} & ( 3 )\end{matrix}$$

Here, β is a positive floating point number and is a weighting value for determining which of recall and precision is to be prioritized. Note that Recall_{NER} (named entity recall rate) is the number of named entities that have been able to be accurately extracted/the number of named entities after correction and can be obtained by Formula (4) below.

$$\begin{matrix}[ Mathematical Formula 4 ] & \\ {recall}_{NER} = \frac{( number of named entities after correction - number of added named entities )}{( number of named entities after correction )} & ( 4 )\end{matrix}$$

Also, Precision_{NER} (named entity precision rate) is the number of named entities that have been able to be accurately extracted/the number of named entities before correction and can be obtained by Formula (5) below.

$$\begin{matrix}[ Mathematical Formula 5 ] & \\ {precision}_{NER} = \frac{( number of named entities before correction - number of corrected named entity errors )}{( number of named entities before correction )} & ( 5 )\end{matrix}$$

Also, Recall_{RE} (relationship recall rate) is the number of relationships that have been able to be accurately extracted/the number of relationships after correction and can be obtained by Formula (6) below.

$$\begin{matrix}[ Mathematical Formula 6 ] & \\ {recall}_{RE} = \frac{( number of relationships after correction - number of added relationships )}{( number of relationships after correction )} & ( 6 )\end{matrix}$$

Also, precision_{RE} (relationship precision rate) is the number of relationships that have been able to be accurately extracted/the number of relationships before correction and can be obtained by Formula (7) below.

$$\begin{matrix}[ Mathematical Formula 7 ] & \\ {precision}_{RE} = \frac{( number of relationships before correction - number of corrected relationship errors )}{( number of relationships before correction )} & ( 7 )\end{matrix}$$

Note that the number of named entities before correction is the number of named entities in the knowledge graph before correction. Also, the number of named entities after correction is the number of named entities in the knowledge graph after correction. Also, the number of relationships before correction is the number of relationships in the knowledge graph before correction. Also, the number of relationships after correction is the number of relationships in the knowledge graph after correction. Moreover, the number of named entities that have been able to be accurately extracted is the number of named entities that have not changed before and after correction. Also, the number of relationships that have been able to be accurately extracted is the number of relationships that have not changed before and after correction.

In the case of correction of the knowledge graph illustrated as an example in FIG. 14, for example, the number of added named entities is 1 (the addition of “damage”), the number of corrected errors in named entities is 3 (for example, the correction of “diesel” and “engine” and the correction of the “cooling pump” from “status” to “component”: total of three corrected errors), recall_{NER} indicating the named entity recall rate is 3/4, precision_{NER} indicating the named entity precision rate is 1/4, the number of added relationships is two (the addition of “cooling pump “is” damaged” and “damage “cause” automatic stop: total of two added relationships), the number of corrected errors in relationships is one (the correction of “cooling pump “cause” automatic stop: total of one corrected error), recall_{RE} indicating the relationship recall rate is 1/3, precision_{RE} indicating the relationship precision rate is 1/2, and the correction burden is 0.6125 (when β=1 and γ=1). These are obtained by Formulae (1) to (7) above.

Next, the processor 10 updates the defect knowledge DB 120 (Step S70). Specifically, the processor 10 stores the generated knowledge graph (the knowledge graph after correction in the case where the knowledge graph is corrected in Step S50), the calculated knowledge graph feature amount, and the correction feature amount in the defect knowledge DB 120 and updates the database. Next, the processor 10 updates the defect knowledge DB 120 and then ends this flow.

The knowledge DB update processing has been described above.

According to such a processor system, it is possible to reflect a pattern of correction performed in the past to next and subsequent generation of knowledge graphs and to thereby generate a knowledge graph with high accuracy from a defect report sentence. As a result, a work load for manually correcting the knowledge graph can be minimized.

In addition, according to the processor system, the knowledge graph feature amount is generated, this is registered in the database in association with the knowledge graph, and it is thus possible to search for an appropriate reference case from the database in the next and subsequent generation of knowledge graphs.

According to the processor system, in the case where the generated knowledge graph is corrected, the correction feature amount is registered in the database. It is thus possible to select a reference case on which more corrections have been performed from among reference cases similar to the processing target defect when a knowledge graph is generated. More detailed and a larger number of corrections with human intervention have typically been performed on knowledge graphs with high accuracy in many cases. Therefore, it is possible to generate a knowledge graph with high accuracy reflecting more correction patterns by generating the knowledge graph using a similar reference case with a large correction feature amount.

Next, a user interface in the processor system 100 will be described. The user interface is screen information generated by the processor 10 using various kinds of information in the memory resource 20, information generated by the processor system 100, and the like and is displayed on an output device connected via the UI 40. Note that the user interface may be displayed on, for example, an output device of the external device 400 connected via a network N.

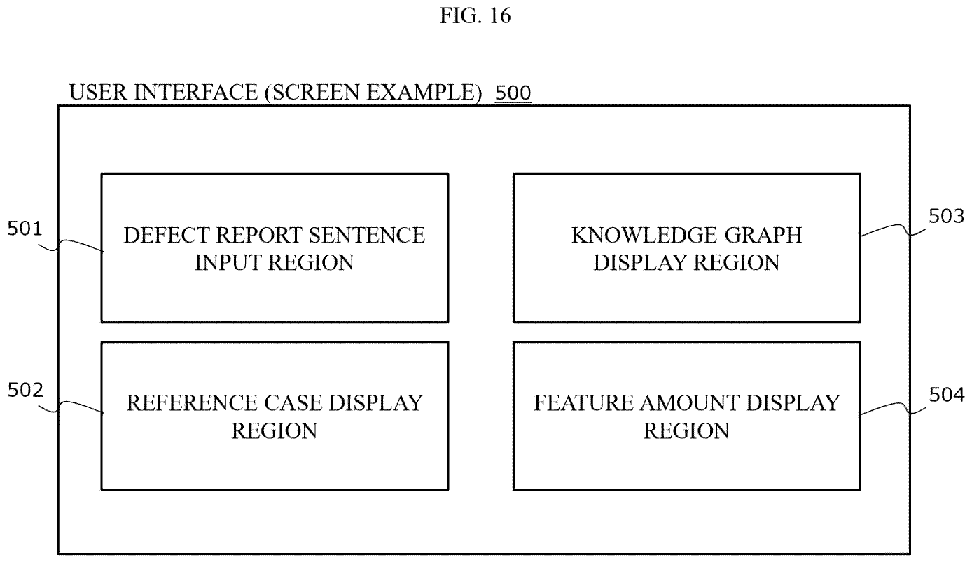

FIG. 16 is a diagram illustrating an example of a user interface screen. As illustrated in the drawing, a user interface screen 500 includes a defect report sentence input region 501, a reference case display region 502, a knowledge graph display region 503, and a feature amount display region 504.

The defect report sentence input region 501 is a region for receiving an input of a defect report sentence to be processed. Specifically, a plurality of defect report sentences stored in the defect report sentence DB 130 are displayed in the defect report sentence input region 501, and the user selects a defect report sentence to be processed. Note that in a case where a defect report sentence is selected or a processing execution receiving button is pressed, the processor 10 executes the knowledge DB update processing.

The reference case display region 502 is a region in which the knowledge information (for example, at least one of the case knowledge graph, the case knowledge graph feature amount, and the correction feature amount) of the reference case extracted from the defect knowledge DB 120 on the basis of the feature amount of the defect report sentence is displayed.

The knowledge graph display region 503 is a region for displaying the knowledge graph generated on the basis of the reference case. Note that in a case where the generated knowledge graph has been corrected, both the knowledge graph before correction and the knowledge graph after correction may be displayed. Note that in that case, the corrected location may be highlighted or may be displayed in an emphasized manner with bold letters.

The feature amount display region 504 is a region for displaying at least one of the knowledge graph feature amount and the corrected feature amount. Specifically, the knowledge graph feature amount of the vector embedding format and the correction burden that is the corrected feature amount are displayed in the feature amount display region 504.

Note that although the regions are included in one screen in the illustrated example, the present invention is not limited thereto, and the processor 10 may display each region in each screen or display regions of a predetermined combination (for example, a combination of the defect report sentence input region 501 and the knowledge graph display region 503) in one screen.

### Second Embodiment

Although the processor 10 performs correction processing (Step S50) on named entities and the relationships among the named entities on the basis of the basic data in the above-described first embodiment, a processor system 100 according to a second embodiment corrects named entities and relationships among the named entities on the basis of a user's operation when a correction instruction is received from the user asynchronously with knowledge DB update processing.

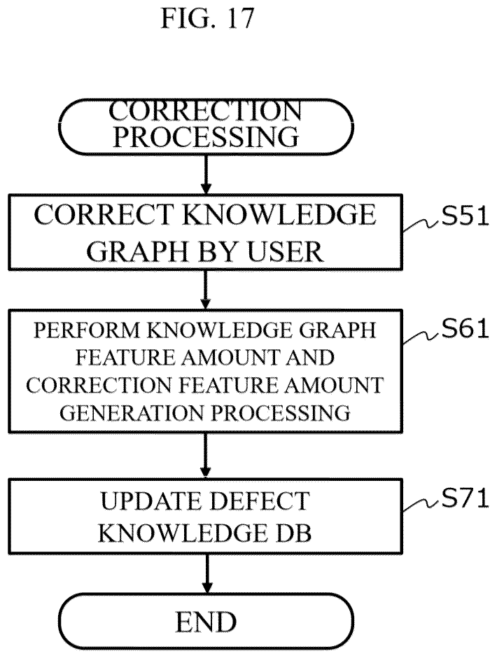

FIG. 17 is a flowchart illustrating an example of correction processing according to the second embodiment.

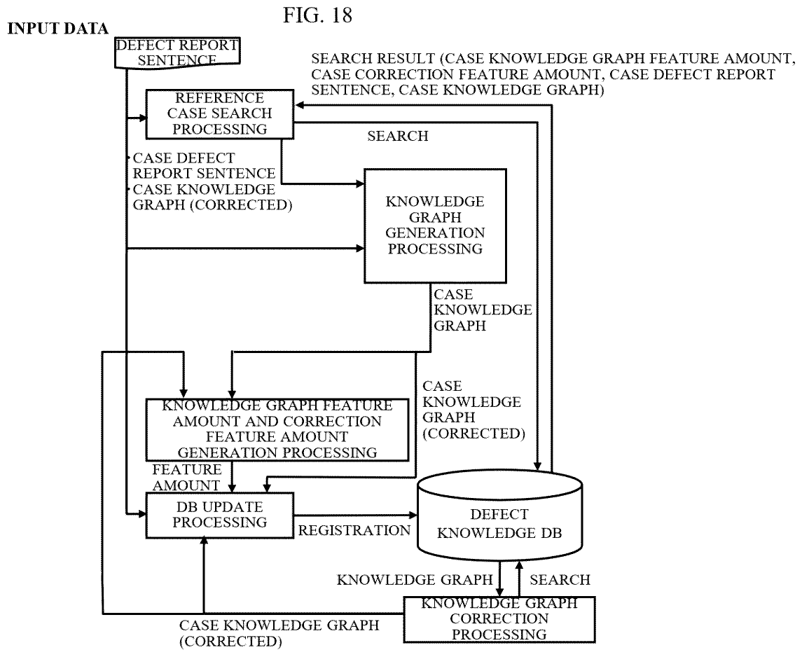

FIG. 18 is an explanatory diagram of the entire knowledge DB update processing including a data flow. As illustrated in the drawing, the processor 10 executes the correction processing at a timing when an instruction to correct a knowledge graph is received from the user, receives an operation related to correction from the user, and corrects the knowledge graph. In addition, the processor 10 generates the feature amount of the knowledge graph after correction and correction feature amount and registers them along with the knowledge graph after correction in the defect knowledge DB 120.

Specifically, the processor 10 receives a correction operation performed by the user in regard to the named entities and the relationships among the named entities of the knowledge graph via the user interface in the processing in Step S51.

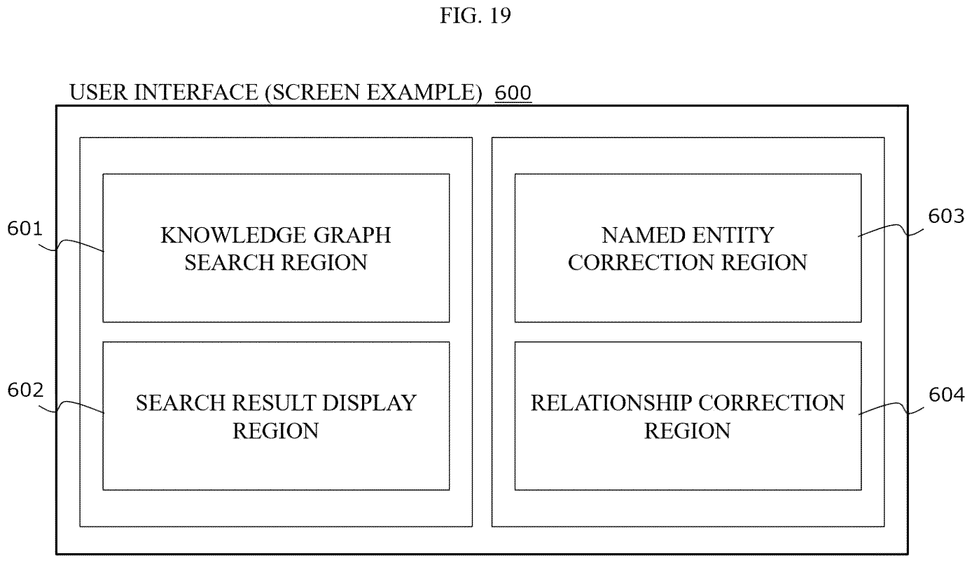

FIG. 19 is a diagram illustrating an example of a user interface screen 600. As illustrated in the drawing, the user interface screen includes a knowledge graph search region 601, a search result display region 602, a named entity correction region 603, and a relationship correction region 604.

The knowledge graph search region 601 is a region for receiving an input of information to search for a knowledge graph to be corrected (indicating a case knowledge graph since it is registered in the defect knowledge DB 120 in this case; hereinafter, this may be referred to as a “knowledge graph to be corrected”) from the defect knowledge DB 120. The user inputs an identification number, a name, or the like for specifying the knowledge graph to be corrected via the input device connected to the UI 40. At this time, the processor 10 searches for the defect knowledge DB 120 on the basis of the input information, extracts the corresponding knowledge graph, and displays the knowledge graph in the search result display region 602. Note that the processor 10 extracts the corresponding defect report sentence along with the knowledge graph to be corrected.

As described above, the search result display region 602 is a region for displaying the knowledge graph to be corrected.

The named entity correction region 603 is a region for displaying the defect report sentence (case defect report sentence) corresponding to the searched knowledge graph to be corrected and receiving correction of named entities. The processor 10 displays the defect report sentence corresponding to the knowledge graph to be corrected in the corresponding region 603. At this time, the processor 10 generates a named entity list (illustrated as an example in FIG. 11) from the knowledge graph to be corrected, specifies the named entities included in the defect report sentence using the list, and displays them in an emphasized manner with bold letters or highlighting. Note that the processor 10 may add attributes such as “component” and “status” to the displayed named entities and display them together.

In addition, the user operates the named entity correction region 603 and corrects the displayed named entities. Specifically, the user selects the named entities displayed by highlighting or the like and corrects them to accurate named entities. Once the correction based on the user's operation is received, the processor 10 reflects this to the knowledge graph to be corrected.

Furthermore, the relationship correction region 604 is a region for displaying the knowledge graph to be corrected and receiving correction for relationships between the nodes. Specifically, the user selects an edge (arrow line) connecting nodes and performs an operation of changing a start or an end or adding a new edge between the nodes. Once the correction based on the user's operation is received, the processor 10 reflects this to the knowledge graph to be corrected.

After such correction is received, the processor 10 generates a knowledge graph feature amount and a correction feature amount of the knowledge graph after correction. In addition, the processor 10 registers the knowledge graph after correction, the knowledge graph feature amount, and the feature amount after correction in the defect knowledge DB 120 and ends the correction processing. Note that the processing in Steps S61 and S71 corresponds to Steps S60 and S70 described above and detailed description thereof will thus be omitted.

The processor system 100 of the second embodiment has been described above.

It is possible to reflect patterns of correction performed in the past to the next and subsequent generation of knowledge graphs even with such a processor system and to thereby generate a knowledge graph with high accuracy from a defect report sentence.

In particular, the processor system receives correction from the user and corrects the knowledge graph, and it is thus possible to accumulate knowledge graphs with higher accuracy as case knowledge information. In addition, the knowledge graph to be corrected has high accuracy because it reflects correction patterns in the past for reference cases in the generation stage of the knowledge graph to be corrected, and as a result, the user can perform correction with a minimum burden.

Note that the present invention is not limited to the above-described embodiments and modifications and includes various modifications within the same scope of technical idea. For example, the above-described embodiments have been described in detail for easy explanation of the present invention, and the present invention is not necessarily limited to embodiments including all the described configurations. In addition, some of configurations in a certain embodiment can be replaced with configurations in another embodiment, and it is also possible to add configurations in another embodiment to configurations in a certain embodiment. Moreover, addition, deletion, and replacement of other configurations can be made for some of configurations in each embodiment.

The control lines and the information lines that are considered to be necessary for explanation are illustrated in the above description, and the description does not necessarily illustrate all the control lines and information lines in the product. It may be considered that almost all the configurations are connected to each other in practice.

What is claimed is:

1. A processor system comprising: one or more processors; and one or more memory resources,
wherein the memory resource stores a defect knowledge database in which case knowledge information including corrected knowledge graphs in regard to defects in a product or a part is stored, a language processing model, a target defect report sentence, and a program that generates a knowledge graph related to the target defect report sentence, and
the processor executes the program to
extract the case knowledge information in which case knowledge similar to the defect indicated by the target defect report sentence is registered from the defect knowledge database, and
specify named entities and relationships among the named entities in the target defect report sentence by inputting the target defect report sentence and the extracted case knowledge information to the language processing model and generate a knowledge graph related to the target defect report sentence on the basis of the specified named entities and the relationships.

2. The processor system according to claim 1,
wherein the processor corrects at least either the named entities or the relationships in the knowledge graph related to the target defect report sentence in accordance with a predetermined restriction.

3. The processor system according to claim 2,
wherein the processor
generates a knowledge graph feature amount, which is a feature amount of the knowledge graph related to the target defect report sentence and a correction feature amount that is a feature amount related to the correction, and
stores the generated knowledge graph, the knowledge graph feature amount, and the correction feature amount as case knowledge information in the defect knowledge database.

4. The processor system according to claim 1,
wherein the case knowledge information includes a knowledge graph, a knowledge graph feature amount, and a correction feature amount of the knowledge graph, and
the processor extracts the case knowledge information with higher similarity to the feature amount of the target defect report sentence and the larger correction feature amount as case knowledge information to be used to generate a knowledge graph related to the target defect report sentence from the defect knowledge database.

5. The processor system according to claim 1,
wherein the case knowledge information includes a knowledge graph and a case defect report sentence corresponding to the knowledge graph, and
the processor inputs an instruction to extract named entities related to a defect from the target defect report sentence to the language processing model on the basis of the extracted knowledge graph and the case defect report sentence of the case knowledge information.

6. The processor system according to claim 5,
wherein the processor inputs, to the language processing model, an instruction to extract relationships among the named entities using the target defect report sentence and the named entities extracted from the target defect report sentence on the basis of the extracted knowledge graph and the case defect report sentence of the case knowledge information.

7. The processor system according to claim 3,
wherein the processor generates the knowledge graph feature amount representing named entities and relationships among the named entities included in the knowledge graph related to the target defect report sentence in a vector embedding format using a predetermined learning model.

8. The processor system according to claim 3,
wherein the processor generates a correction feature amount indicating a degree of correction burden on the basis of the number of named entities, the number of relationships, the numbers of added named entities and relationships, and the number of corrected errors through comparison between the knowledge graph before correction related to the target defect report sentence and the knowledge graph after correction.

9. The processor system according to claim 1,
wherein the case knowledge information includes a knowledge graph and a case defect report sentence corresponding to the knowledge graph, and
the processor
performs searching in the defect knowledge database on the basis of a user's instruction, and
receives, from the user, correction related to at least either the searched knowledge graph of the case knowledge information or the named entities and relationships among the named entities specified from the case defect report sentence.

10. The processor system according to claim 1,
wherein the processor generates screen information for performing display in at least any one or more regions from among a region for receiving an input of the target defect report sentence, a region for displaying the case knowledge information extracted from the defect knowledge database, a region for displaying the generated knowledge graph, and a region for displaying at least either a feature amount of the generated knowledge graph or a correction feature amount of the knowledge graph.

11. The processor system according to claim 1,
wherein the case knowledge information includes a knowledge graph and a case defect report sentence corresponding to the knowledge graph, and
the processor generates screen information for performing displaying in at least any one of regions from among a region for receiving an input of information for specifying the case knowledge information to be corrected, a region for displaying the case knowledge information extracted from the defect knowledge database on the basis of input information, a region for displaying named entities of the case defect report sentence included in the case knowledge information and receiving a correction operation, and a region for displaying the knowledge graph included in the case knowledge information and receiving an operation for correcting relationships among named entities.

12. A knowledge graph generation method performed by a processor system including one or more processors and one or more memory resources,
the memory resource
storing a defect knowledge database in which case knowledge information including a corrected knowledge graph related to defects in a product or a part is stored, a language processing model, a target defect report sentence, and a program for generating a knowledge graph related to a target defect report sentence,
the method comprising
by the processor, executing the program to:
extract the case knowledge information in which case knowledge similar to the defect indicated by the target defect report sentence is registered from the defect knowledge database; and
specify named entities and relationships among the named entities in the target defect report sentence by inputting the target defect report sentence and the extracted case knowledge information to the language processing model and generate a knowledge graph related to the target defect report sentence on the basis of the specified named entities and the relationships.

13. A program executed by a processor system including one or more processors and one or more memory resources,
the memory resource
storing a defect knowledge database in which case knowledge information including a corrected knowledge graph related to defects in a product or a part is stored, a language processing model, and a target defect report sentence,
the program causing the processor to execute processing of:
extracting the case knowledge information in which case knowledge similar to the defect indicated by the target defect report sentence is registered from the defect knowledge database; and
specifying named entities and relationships among the named entities in the target defect report sentence by inputting the target defect report sentence and the extracted case knowledge information to the language processing model and generating a knowledge graph related to the target defect report sentence on the basis of the specified named entities and the relationships.
